(19) United States
(12) Patent Application Publication
(10) Pub. No.: US 2017/0001601 A1
(43) Pub. Date: Jan. 5, 2017

(54) ONE BODY TYPE RAIN SENSOR WITH REFLECTION TYPE SENSOR FOR DETECTING EXTERNAL OBJECT

(71) Applicants: Hyundai Motor Company, Seoul (KR); Kia Motors Corporation, Seoul (KR)

(72) Inventors: Jin Sang Lee, Seoul (KR); Yong Pyo Hong, Iksan (KR); Nam Joon Yoo, Iksan (KR); Jong Min Park, Seoul (KR)

(21) Appl. No.: 15/189,985

(22) Filed: Jun. 22, 2016

(30) Foreign Application Priority Data
Jul. 3, 2015 (KR) 10-2015-0095002

(51) Int. Cl. B60S 1/08; G01V 8/20

(52) U.S. Cl. CPC B60S 1/0833; G01V 8/20

(57) ABSTRACT

A one-body type rain sensor is attached to a vehicle glass to differentiate a raindrop and an external object which fall down onto the vehicle glass, where the one-body type rain sensor includes a light emission unit which emits light which is inputted onto the vehicle glass, a second light emission module which emits light which is inputted onto the vehicle glass, a light receiving unit which receives the light which is emitted from the light emission unit and the second light emission unit and reflected off the vehicle glass, and a control unit which outputs the light that the light receiving unit has received, in the form of a signal, thereby operating a wiper of the vehicle.

### CROSS-REFERENCE TO RELATED APPLICATION

This application claims under 35 U.S.C. §119(a) the benefit of Korean Patent Application No. 10-2015-0095002 filed on Jul. 3, 2015, the entire contents of which are incorporated herein by reference.

### BACKGROUND

(a) Technical Field

The present invention relates to a one-body type rain sensor with a reflection type sensor for detecting an external object, more particularly, to the one-body rain sensor with the reflection type sensor which is attached to a vehicle glass so as to detect and differentiate a raindrop, an external object, etc. on the vehicle glass and is configured to generate a signal to control a driving and operation speed and cycle of a vehicle wiper based on the kind, amount and falling cycle of the detected object.

(b) Description of the Related Art

Generally, a vehicle is equipped with a wiper to remove rain water from a vehicle glass when it is raining, and wipe and clean the vehicle glass which has been dirtied with muddy water, dust, etc. The wiper is configured to be selectively activated with the aid of a wiper activation switch when a vehicle driver wants to activate the wiper.

In recent years, the wiper is configured to automatically operate by installing a rain sensor at the vehicle glass, where the rain sensor is able to automatically detect the intensity and amount of the rain water falling down onto the vehicle glass without a separate driver's operation, thereby automatically controlling the speed or operation time of the wiper.

The above-mentioned rain sensor is configured to start operating when the raindrop is detected on the vehicle glass. In this case, the rain sensor may detect any raindrop or external object on the outer side surface of the vehicle glass and may operate the wiper, resulting in damage to the wiper or a wiper motor.

For example, if the rain sensor detects any ice or frost on the vehicle glass in winter, and the wiper is operated in such a situation, the wiper or the wiper motor may be damaged. If the wiper operates while mud or muddy water is stuck on the vehicle glass, the vehicle glass may be damaged as well. Moreover, if the wiper is driven in a state where an external object is stuck on the vehicle glass, a vehicle driver's view may be interrupted due to the presence of the external object.

Korean Laid-Open Patent Publication No. 10-2010-0059008 discloses a method for sensing rain. According to this document, when light which has been emitted from a light source is reflected off a raindrop which has fallen on a vehicle window glass, an optical signal is sensed by a light receiving element, thereby detecting the raindrop, and if the amount of the detected raindrop reaches a set threshold value, the wiper of the vehicle is operated in response to a detection signal, by which the wiper can operate based on the amount of the raindrop. The time to be taken to reach the threshold value can be measured by detecting the raindrop to adjust the operation speed of the wiper based on the amount of rain fall.

However, the above-described document of the related art discloses only a method for sensing rain. The detection of a predetermined object other than a raindrop and an operation control according to the detection are not described, and thus the above-described document of the related art is not able to resolve the above-described problems.

Korean Patent Application No. 10-2014-0066534 discloses a total reflection mode rain sensor using a mirror. This technology is directed to a rain sensor which is attached to a vehicle glass, which is formed of a light emission unit which is able to emit light onto a vehicle glass, a light receiving unit which is configured to receive the light which has been emitted from the light emission unit and has been totally reflected off the vehicle glass, an adhering unit which may attach the rain sensor to the vehicle glass, and a control unit which is provided to receive a signal from the light receiving unit that has received the light and activate the wiper of the vehicle. In this total reflection type rain sensor using a mirror, a threshold value with respect to the amount of raindrop is stored, and if the threshold value is over a predetermined value, a signal is outputted to activate the wiper.

According to the above-described total reflection rain sensor using a mirror, the operation speed and cycle of the wiper of the vehicle can be controlled by the control unit which is configured to receive a signal of the light receiving unit which has received the total reflection light, the intensity of which differs based on the amount of the raindrop.

The above-described technology, however, does not describe the detection of objects, except the raindrop, and an operation control according to the detection, and thus it is impossible to resolve the above-described problems.

For this reason, there is a need for a new technology which is able to differentiate a raindrop from an external object with the aid of a rain sensor and control the operation of a wiper based on a result of the differentiation.

Moreover, there is a need to develop a new technology which may make it possible to minimize the unnecessary operation of the wiper in such a way to control the operation speed and cycle of the wiper based on the amount and falling cycle of the detected raindrop.

The above information disclosed in this Background section is only for enhancement of understanding of the background of the invention and therefore it may contain information that does not form the prior art that is already known in this country to a person of ordinary skill in the art.

### SUMMARY

An object of the present invention is to provide a one-body type rain sensor with a reflection type sensor which is attached to a vehicle glass so as to detect and differentiate a raindrop, an external object, etc. on the vehicle glass and is configured to generate a signal to control a driving and operation speed and cycle of a vehicle wiper based on the kind, amount and falling cycle of the detected object, wherein the one-body type rain sensor with a reflection type sensor may include a light emission unit which is able to emit light which is inputted into the vehicle glass; a second light emission module which is able to emit light which is inputted onto the vehicle glass; a light receiving unit which is provided to receive the light which has emitted from the light emission unit and the second light emission module and has been reflected off the vehicle glass; and a control unit which is able to output the light that the light receiving unit has received, in the form of a signal, thereby operating a wiper of the vehicle.

Accordingly, in one aspect, the present invention provides a one-body type rain sensor with a reflection type sensor which is formed of a light emission unit, a second light emission module, a light receiving unit and a control unit and is attached to a vehicle glass so as to detect and differentiate a raindrop, an external object, etc. which fall onto the vehicle glass. The light receiving unit receives light, which is emitted from the light emission unit and then totally reflected off a vehicle glass, and light, which is emitted from the second light emission module and then reflected off a vehicle glass, and outputs signals for the amount of the received light. The control unit analyzes the signals output by the light receiving unit and outputs a control signal to control the driving, operation speed and cycle of a wiper of the vehicle depending on conditions of raindrops and foreign substances.

Other aspects and preferred embodiments of the invention are discussed infra.

The one-body type rain sensor with a reflection type sensor according to the present invention is attached to a vehicle glass so as to detect and differentiate a raindrop, an external object, etc. on the vehicle glass and is configured to generate a signal to control a driving and operation speed and cycle of a vehicle wiper based on the kind, amount and falling cycle of the detected object, and accordingly any damage to the wiper and the wiper motor can be prevented, and it is possible to minimize the unnecessary operations of the wiper.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view schematically illustrating a light travel route based on an internal configuration and operation of a one-body type rain sensor with a reflection type sensor according to the present invention;

FIG. 2 is a view schematically illustrating a light travel route based on another example and operation of an internal configuration of a one-body type rain sensor with a reflection type sensor according to the present invention;

FIG. 3 is a view schematically illustrating a light travel route at a light emission module if a raindrop falls down onto a vehicle glass in a one-body type rain sensor with a reflection type sensor according to the present invention; and

FIGS. 4a to 4d are views schematically illustrating light travel routes which change based on the kinds of external objects which have fallen down onto a vehicle glass in a one-body type rain sensor with a reflection type sensor according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention is directed to a one-body type rain sensor with a reflection type sensor which is attached to a vehicle glass so as to detect and differentiate a raindrop, an external object, etc. on the vehicle glass and is configured to generate a signal to control a driving and operation speed and cycle of a vehicle wiper based on the kind, amount and falling cycle of the detected object.

The external object means a substance, for example, mud or muddy water, which may splash onto a vehicle glass in the course of driving or a substance, for example, frost or ice, which may be different depending on the weather or the particular season (i.e., spring, summer, fall, or winter). More specifically, the external object means various substances except a raindrop.

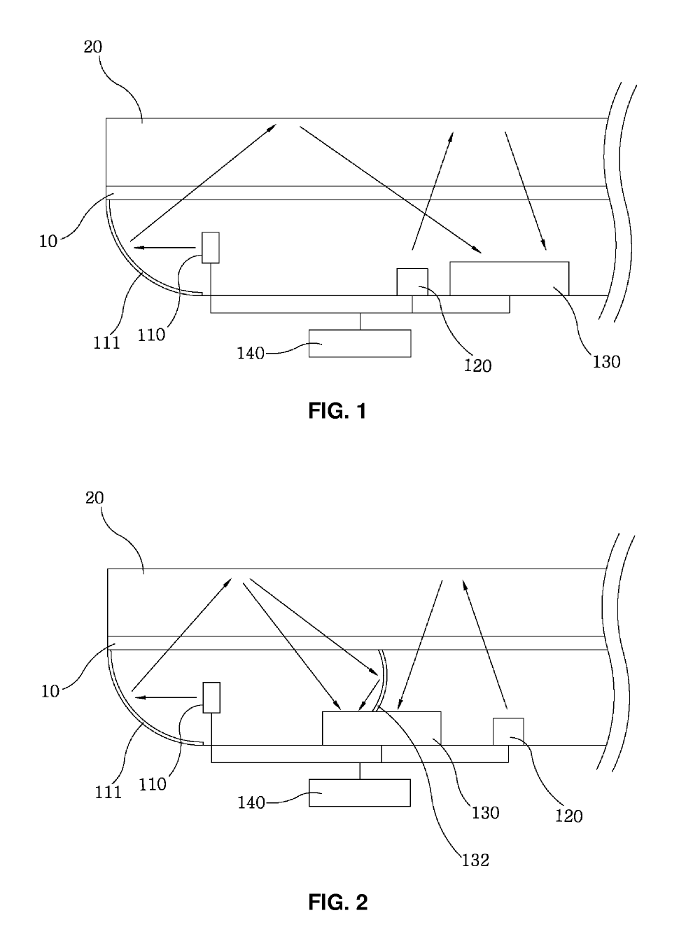

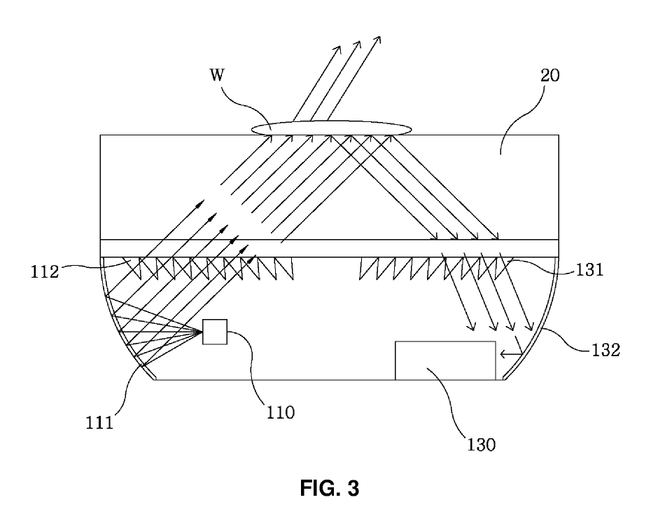

The light travel route based on the configuration and operation of the one-body type rain sensor with a reflection type sensor according to the present invention will be described with reference to FIGS. 1 and 2.

FIG. 1 is a view schematically illustrating a light travel route based on an internal configuration and operation of a one-body type rain sensor with a reflection type sensor according to the present invention, and FIG. 2 is a view schematically illustrating a light travel route based on another example and operation of an internal configuration of a one-body type rain sensor with a reflection type sensor according to the present invention.

The rain sensor in FIG. 1 may be installed using an adhering surface 10 which is attached to the front surface of a vehicle glass 20, thereby detecting raindrops and external objects which fall down onto the vehicle glass 20. It is preferred that the adhering surface 10 is made of a silicon material.

As illustrated in FIG. 1, the rain sensor may include a first light emission module 110, a light emission parabolic mirror module 111, a second light emission module 120, a light receiving unit 130, and a control unit 140.

It is preferred that the first light emission module 110, the second light emission module 120 and the light receiving unit 130 of the rain sensor according to the present invention are mounted where the light emitted from the first light emission module 110 and the second light emission module 120 can be reflected or fully reflected off the vehicle glass 20 and can be received by the light receiving unit 130.

The light emission unit may be formed of a first light emission module 110 which is able to emit light, and a light emission parabolic mirror module 111.

The first light emission module 110 is capable of emitting light, wherein the light may be any of various types of light, but it is preferably an infrared ray. Moreover, the light emitting from the first light emission module 110 is controlled to travel in the direction of the light emission parabolic mirror module 111.

The light emission parabolic mirror module 111 may include a parabolic reflection surface, as illustrated in FIG. 1, to reflect the light emitted from the first light emission module 110 toward the direction of the vehicle glass 20.

The light having a parallel wavelength in general can be condensed using a parabolic mirror. The rain sensor according to the present invention is employing the above feature in a reverse way. More specifically, the light emitted from the first light emission module 110 is reflected in the parallel direction with the aid of the light emission parabolic mirror module 111.

For this, it is preferred that the light emission parabolic mirror module 111 has a curved parabolic surface in order for the light emitted from the first light emission module 110 to be reflected off in the parallel direction.

The second light emission module 120 is able to emit light, and the emitted light will be used to detect any raindrop and external object which have been stuck on the vehicle glass 20.

The light may be any of various types of light. For example, the light may be an infrared ray.

The light emitted from the second light emission module 120 is controlled to emit in the direction of the vehicle glass 20.

The light receiving unit 130 may be formed of a first light receiving module which is able to carry out a function to receive the light which has been emitted from the first light emission module 110, and a second light receiving module which is able to receive the light which has been emitted from the second light emission module 120.

The second light emission module 120 and the second light receiving module, as a reflection type sensor, detect a raindrop (W) and an external object (P) which have fallen down onto the vehicle glass 20.

The light receiving unit 130 is able to output the received light in the form of a signal, which will be transmitted to the control unit 140.

The control unit 140 is provided to receive the signal which has transmitted from the light receiving unit 130 and is able to transmit a control signal to a corresponding vehicle while communicating with the vehicle.

The communication with the vehicle may be carried out via LIN communication.

LIN communication refers to “local interconnect network” communication. Since LIN communication in general is used for data transmission between a vehicle ECU, an active sensor and an active actuator, it can be applicable to the present invention to actively operate the wiper of the vehicle.

The received signal may be analyzed, and an appropriate control signal may be transmitted to a corresponding vehicle based on the state of each of a raindrop (W) and an external object (P). The operation of the wiper of the vehicle can be automatically stopped if an object, which may damage the wiper or a wiper motor, for example, mud, muddy water, ice, etc. not the raindrop (W), is detected.

Since the amount of the raindrop can be judged by a signal, the cycle of the wiper operation and the speed of the wiper of the vehicle can be controlled.

Moreover, a threshold value can be set based on the data of the amount of the received light of the raindrop (W) or the external object (P), and the operation of the wiper can be controlled based on the amount of light that the first light receiving module and the second light receiving module receive.

The threshold value means a minimum value on the amount of the raindrop (W) which may operate the wiper of the vehicle. If the amount of the raindrop is less than a set threshold value, the wiper is not operated, thereby minimizing the unnecessary operation of the wiper.

FIG. 2 is a view illustrating another example of the internal configuration of a one-body type rain sensor with a reflection type sensor according to the present invention. The light travel route may change based on the operation in terms of the position change of the light emission unit, the second light emission module 120 and the light receiving unit 130.

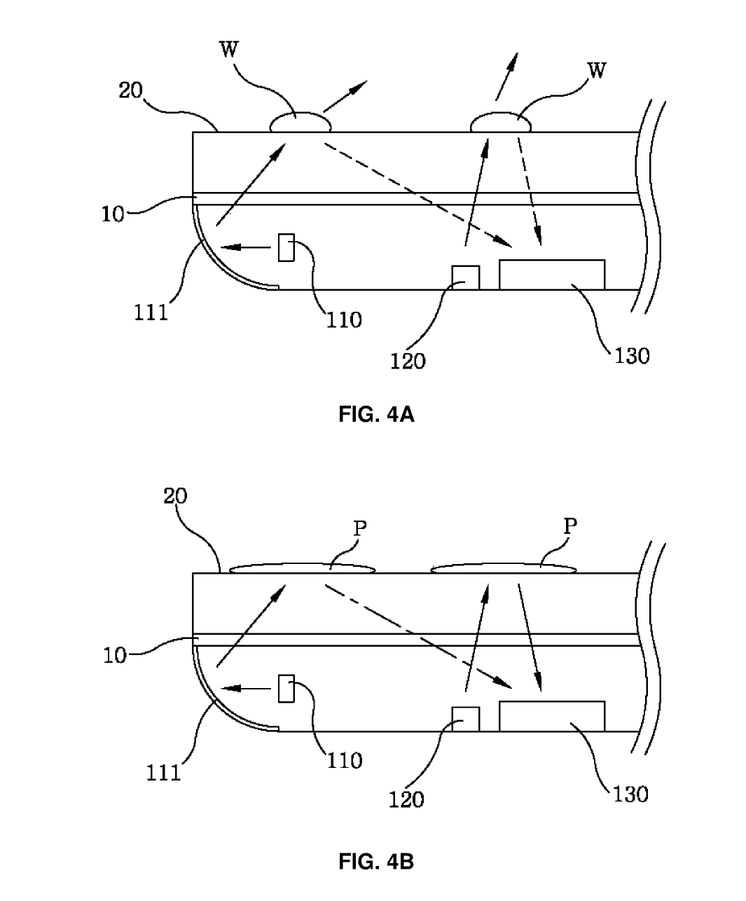

The light receiving unit 130 is interposed between the light emission unit and the second light emission module 120 to receive the light which has been reflected off the vehicle glass 20. In particular, there is provided a light receiving parabolic mirror module 132 which has a parabolic reflection surface so as to reflect light coming out of the light receiving unit 130 among light emitted from the first light emission module 110 and then totally reflected off the vehicle glass 20 toward the first light receiving module of the light receiving unit 130. FIG. 3 is a view schematically illustrating a travel route of the light which has emitted from the first light emission module 110 in a case where raindrops fall down onto the vehicle glass in the one-body type rain sensor with a reflection type sensor according to the present invention.

The light which has emitted from the first light emission module 110 may detect an external object (P) which is stuck on the vehicle glass 20 based on the amount of the light which is fully reflected off the vehicle glass 20. The light should be inputted at an angle which is over a critical angle at which the total reflection can be made, in order for the light to be totally reflected off a predetermined medium. The light emission parabolic mirror module 111 according to the present invention is able to allow the transmitted light to be inputted at an angle at which the light can be totally reflected by adjusting the angle of the light.

The total reflection in general occurs when light moves from a medium having a high refractive index to a medium having a low refractive index. The critical angle is a predetermined angle wherein if the light which is incident on the medium reaches an incident angle over a predetermined angle, the light cannot go out of the medium.

The refractive index of the vehicle glass is about 1.5-1.51, and the refractive index of air is 1. The following formula 1 can be employed so as to calculate the critical angle of the vehicle glass 20 using the above refractive index.

$${θ}_{critical angle} = arcsin ( \frac{{n}_{2}}{{n}_{1}} ) ( wherein {n}_{1} > {n}_{2} ) \qquad ( Formula 1 )$$

wherein the refractive index n₁ means a refractive index of the vehicle glass, and the refractive index n₂ means a refractive index of an external air.

The critical angle obtained using the above formula 1 is about 41.4 degrees. More specifically, the light can be adjusted to input at an angle of over 41.4 degrees in order for the light transmitted through the light emission parabolic mirror module 111 to be totally reflected off the vehicle glass 20.

A light emission tooth-shaped rotation prism 112 is configured to transmit the light which has been reflected off the light emission parabolic mirror module 111.

The light emission tooth-shaped rotation prism 112 may be configured in such a way that a prism which is able to maintain the parallel state of the light which has been reflected off the light emission parabolic mirror module 111 can be disposed protruding in the inward direction.

For this reason, the light which has been reflected off the light emission parabolic mirror module 111 via the light emission tooth-shaped rotation prism 112 can maintain the parallel state and the incident angle.

If the raindrop falls down onto the region where the light inputted at the critical angle can reach, since the medium has a refractive index higher than that of the external air, as illustrated in FIG. 3, even though the light is inputted at a critical angle for the occurrence of the full reflection, the refractive index may change due to the raindrop (W). In this case, even though the light which is inputted onto the vehicle glass 20 is reflected, some of the light is transmitted through the raindrop or is lost.

Therefore, the amount of the light which is received by the first light receiving module of the light receiving unit 130 is lower than when there is no raindrop (W), and thus the raindrop (W) can be detected.

However, there is difficulty in differentiating a raindrop (W) from an external object (P) since the amount of the received light is small due to transmission or loss of some of the light through the external object (P). Therefore, according to the present invention, the rain sensor is equipped with the second light emission module 120 and the second light receiving module, and the reflection light of the external object (P) which has fallen onto the vehicle glass can be detected together, and the external object (P) which has fallen onto the vehicle glass can be differentiated based on the amount of the light which is received by the light receiving unit 130.

Moreover, the light receiving tooth-shaped rotation prism 131 is installed at the rain sensor, and accordingly the light totally reflected off the vehicle glass 20 can be received by the first light receiving module of the light receiving unit 130, and a corresponding light can be received biased in the direction of the first light receiving module.

More specifically, the light which has been inputted in parallel can be guided to be concentrated to the maximum at a portion while passing through the prism of the light receiving tooth-shaped rotation prism 131. Accordingly, the light receiving tooth-shaped rotation prism 131 is designed so that the region where the light is concentrated via the prism can correspond to the first light receiving module of the light receiving unit 130.

The light receiving tooth-shaped rotation prism 131 is disposed symmetrical with a light emission tooth-shaped rotation prism 112 about a predetermined central line in the vertical direction.

According to a design condition of the present invention, at least two light emission units may be provided. The light receiving tooth-shaped rotation prism 131 may be configured in such a way that the direction of the prism can be rotatable (adjusted) in order for the light which has been emitted from each light emission unit, to be totally reflected off the vehicle glass 20 and to be received by the first light receiving unit. The rotation means a direction adjustment, not meaning a rotation about a predetermined axis.

The rain sensor according to the present invention may further include a light receiving parabolic mirror module 132.

The light receiving parabolic mirror module 132 may have a parabolic reflection surface which is able to reflect the light coming out of the light receiving unit 130 among light emitted from the first light emission module 110 and then totally reflected off the vehicle glass 20 to the light receiving unit 130.

More specifically, since the rain sensor of the present invention is configured as illustrated in FIG. 3, the light which has been fully reflected off the vehicle glass 20 can be more efficiently received, thereby enhancing the function of the detection.

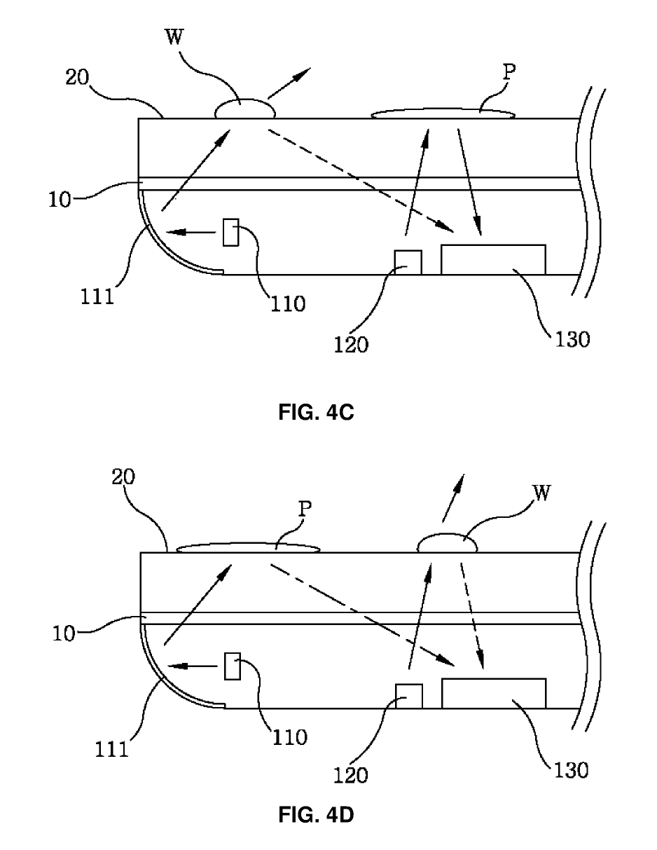

FIGS. 4a to 4b are views schematically illustrating light travel routes which change based on the kinds of external objects which have fallen down onto a vehicle glass in a one-body type rain sensor with a reflection type sensor according to the present invention.

The arrows indicated by a solid line in FIGS. 4a to 4b mean that the amount of the received light is large, and the arrows indicated by an alternate long and short dash line mean that the amount of the received light is small, and the arrows indicated by a dotted line mean that the amount of the received light is smaller than that of the light indicated by the alternate long and short dash line.

As illustrated in FIG. 4a, when the raindrop (W) is detected, if the light which has been emitted from the first light emission module 110 is inputted at a critical angle into the region where the raindrop (W) is on the vehicle glass 20, some of the light may be transmitted or may be lost via the raindrop (W) which has a higher refractive index than that of air, and a small amount of the light can be received by the first light receiving module of the light receiving unit 130. Moreover, some of the light which has been emitted from the second light emission module 120 may be transmitted or may be lost, and a small amount of the light can be received by the second light receiving module of the light receiving unit 130. The light receiving unit 130, therefore, will detect and analyze the light which has been reflected off the rainwater (W) and will output a signal.

As illustrated in FIG. 4b, when the external object (P) is detected, if the light which has been emitted from the first light emission module 110 is inputted at a critical angle into the region where the external object (P) is on the vehicle glass 20, some of the light may be transmitted or may be lost via the external object (P) which has a refractive index higher than air, and a small amount of the light can be received by the first light receiving module of the light receiving unit 130. Meanwhile, the light which has been emitted from the second light emission module 120 may have a little or small amount of the light which may be transmitted or be lost, and accordingly a large amount of the light can be reflected and received by the second light receiving module of the light receiving unit. The light receiving unit 130, therefore, will detect and analyze the light which has been reflected off the external object (P) and will output a signal.

If the light which has been emitted from the first light emission unit 110 is inputted, some of the light may be transmitted toward the outside or may be lost through the external object (P), but the amount of the reflected light is larger than that of the raindrop (W), the light is indicated in the drawings by the alternate long and short dash line so as to express such an operation.

As illustrated in FIG. 4c and FIG. 4d, the difference in the amount of the light which is received when detecting the raindrop (W) and the external object (P) on the outer surface of the vehicle glass 20 can be compared and analyzed.

Referring to FIG. 4c, if the light which has emitted from the first light emission module 110 is inputted onto the raindrop (W), some of the light may be transmitted or may be lost, and thus a small amount of the light will be received by the first light receiving module of the light receiving unit 130, and if the light which has been emitted from the second light emission module 120 is inputted onto the external object (P), a large amount of the light will be reflected and received by the second light receiving module.

Referring to FIG. 4d, if the light which has been emitted from the first light emission module 110 is inputted onto the external object (P), some of the light may be transmitted or may be lost, and thus a small amount of the light will be received by the first light receiving module of the light receiving unit 130, and if the light which has been emitted from the second light emission module 120 is inputted onto the raindrop (W), some of the light may be transmitted toward the outside or may be lost, and thus a small amount of the light will be received by the second light receiving module of the light receiving unit 130.

In this way, the raindrop (W) and the external object (P) can be differentiated based on the difference in the amount of the light which is received by the first light receiving module and the second light receiving module of the light receiving unit 130, and a control signal which may operate the wiper based on the set threshold value can be transmitted to the control unit 140.

Referring to FIG. 4c and FIG. 4d, if an external object is mixed with water and muddy water, it may be detected as a raindrop. In this case, it will be determined whether or not the wiper is operated by analyzing the amount of the light which is received by the light receiving unit 130.

A signal which may control the operation of the wiper can be outputted in such a way to differentiate and analyze the kinds of the objects which are stuck on the outer surface of the vehicle glass 20 by comparing and analyzing the intensities of the light received by the first light receiving module and the second light receiving module of the light receiving unit 130, and accordingly it is possible to prevent any damage to the wiper and the wiper motor and minimize the unnecessary operations of the wiper.

The present invention has been described with FIGS. 1 to 4, focusing on the major components of the present invention. Various modifications are available within the scope of the present invention, and it is obvious that such a description is not limited to the configurations shown in FIGS. 1 to 4.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A rain sensor, comprising:
a light emission unit comprising a first light emission module which is provided to emit light;
a second light emission module;
a light receiving unit; and
a control unit, wherein the rain sensor is attached to a vehicle glass and is able to differentiate a raindrop and an external object except the raindrop, which fall down onto the vehicle glass,
wherein the light receiving unit is configured to receive light which is emitted from the light emission unit and is totally reflected off the vehicle glass, receive light which is emitted from the second light emission module and is reflected off the vehicle glass, and to output a signal with respect to the received light, and the control unit is configured to analyze the signal outputted from the light receiving unit and output a control signal to control a wiper operation, a wiper operation cycle and a wiper operation speed of the vehicle based on the state of the raindrop and the external object.

2. The rain sensor of claim 1, wherein the light emission unit further comprises:
a light emission parabolic mirror module which has a parabolic surface type reflection surface to reflect, in parallel, the light which is emitted from the first light emission module and is able to reflect the light in a direction of the vehicle glass; and
a light emission tooth-shaped rotation prism which is provided to allow the light reflected off the light emission parabolic mirror module to be transmitted in parallel.

3. The rain sensor of claim 2, wherein the light emission parabolic mirror module reflects the light emitted from the first light emission module to be inputted at an angle at which the light is totally reflected off the vehicle glass.

4. The rain sensor of claim 1, wherein the light receiving unit comprises:
a first light receiving module which is provided to receive the light which is emitted from the first light emission module and fully reflected off the vehicle glass; and
a second light receiving module which is provided to receive the light which is emitted from the second light emission module and totally reflected off the vehicle glass.

5. The rain sensor 1, wherein the rain sensor further comprises:
a light receiving parabolic mirror module which has a parabolic surface type reflection surface to reflect light coming out of the light receiving unit toward the light receiving unit, among the light reflected off the vehicle glass; and
a light receiving tooth-shaped rotation prism through which the light totally reflected off the vehicle glass is transmitted.

6. The rain sensor of claim 1, wherein the light emission unit, the second light emission module and the light receiving unit may be disposed in order of the light emission unit, the second light emission module and the light receiving unit or in an order of the light emission unit, the light receiving unit and the second light emission module.

7. The rain sensor of claim 1, wherein at least two light emission units are provided, and at least two detection regions are provided to detect the raindrop and the external object.

8. The rain sensor of claim 1, wherein at least two second light emission modules are provided, and at least two detection regions are provided to detect the raindrop and the external object.
